(19) United States
(12) Patent Application Publication
(10) Pub. No.: US 2009/0317096 A1
(43) Pub. Date: Dec. 24, 2009

(54) IMAGE FORMING APPARATUS, CONTROL METHOD THEREFOR, AND STORAGE MEDIUM

(75) Inventor: Masahiro Odaira, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/486,717

(22) Filed: Jun. 17, 2009

(30) Foreign Application Priority Data
Jun. 23, 2008 (JP) 2008-163669

(51) Int. Cl. G03G 15/00

(52) U.S. Cl. 399/21

(57) ABSTRACT

An image forming apparatus capable of performing operation-checking and an operation for clearing a counter value for a replaced component at component replacement with a simple manipulation, and simple in construction and low in costs. After criterion values for jam detection by a recording-sheet-conveyance-state detection unit that detects sheet feed jam and/or conveyance jam are changed to new component judgment criterion values, whether a roller component has been replaced by a new roller is determined. When replacement to a new roller is determined, a counter value of a life counter for counting the number of times of use of a roller component for detection of replacement time is cleared.

### BACKGROUND OF THE INVENTION

1. Field of the Invention

The present invention relates to an image forming apparatus capable of replacing consumable parts, a control method for the image forming apparatus, and a storage medium storing a program for causing a computer to execute the control method.

2. Description of the Related Art

An image forming apparatus such as a multifunction peripheral can be used for a long time, while replacing consumable parts such as roller components as needed. Since an image forming apparatus is a precision machine, a replacement operation of a consumable part requires a skill and is therefore usually performed by a service personnel.

A service personnel familiar with the construction and mechanism of image forming apparatus has a skill of manual operation-checking at component replacement and is able to empirically determine whether the replacement has been performed satisfactorily.

To determine replacement times of respective consumable parts, some image forming apparatus has counters for counting the numbers of times of use of these consumable parts.

For such image forming apparatus, there has been proposed to provide means manually operable by a service personnel to reset a counter value for a replaced roller component.

In this type of image forming apparatus, a value of a life counter for, e.g., a feed roller is displayed on an LCD panel in a maintenance mode. When a counter reset key is depressed in a state a counter value is displayed, the displayed counter value, i.e., the corresponding counter is reset (see, for example, Japanese Laid-open Patent Publication No. 7-104615).

Another means for resetting a life counter value in an image forming apparatus is to read and analyze an image of a formatted document with checkboxes, which correspond to respective ones of consumable parts. When a marked checkbox is found, a life counter value corresponding to replaced consumable part indicated by the marked checkbox is automatically reset (see, for example, Japanese Laid-open Patent Publication No. 2006-91609).

Also, there has been proposed a system having terminal apparatuses each incorporating consumable parts and managed by a host computer, the host computer being adapted to detect, based on information supplied from the terminal apparatuses on frequency of use of consumable parts, a consumable part of a terminal apparatus that reaches its replacement time (see, for example, Japanese Laid-open Patent Publication No. 6-89287). When any consumable part of any terminal apparatus reaching the replacement time is detected, a service personnel attends a place where the terminal apparatus is installed and detaches and replaces the old consumable part with a new one.

Each consumable part of each terminal apparatus incorporates a fuse, which is adapted to be blown when supplied with an electric current greater than a predetermined current value.

Each terminal apparatus also includes a power supply connected via pull-up resistors to the fuses of the consumable parts and detection means for detecting an electrical potential across each fuse that varies according to whether the fuse has been blown. When the detected potential is at a high level, a CPU of the terminal apparatus determines that the corresponding fuse has been blown and the corresponding consumable part is in use. When the detected potential is at a low level, the CPU determines that the fuse has not been blown and the consumable part has just been replaced by a new consumable part.

When detecting a low-level potential for any consumable part, the CPU initializes a threshold value stored in a non-volatile memory of the terminal apparatus and representing the use frequency limit of the consumable part, and controls the drive of a relay to supply the corresponding fuse with an electric current larger than the predetermined current value to cause the fuse to be blown.

For the terminal apparatus, e.g., image forming apparatus, there is a demand that consumable parts thereof such as roller components be easily replaced even by a user.

However, unlike a service personnel, a general user is not familiar with the construction and mechanism of image forming apparatus, and it is therefore difficult for the user to confirm whether the replacement of consumable part has normally been carried out.

Since a large number of consumable parts are used in every image forming apparatus, it is also difficult for the user to identify a component part to be replaced. In particular, as replacement parts for image forming apparatus, a variety of roller components are available in the market, and the same component is used at different places in one image forming apparatus. Thus, there is a fear that the user makes a mistake in using a replacement component part.

In an image forming apparatus configured to clear a counter value when a corresponding roller component name is manually selected at replacement of a roller component by new one, if a wrong roller component name is selected, a counter value for a roller component different from the actually replaced roller component is cleared. As a result, the counter values for both the roller components become inconsistent with the degrees of consumption thereof, making it impossible to properly determine the next replacement times of these roller components.

If a hardware is used for an arrangement for detecting the replacement to a new consumable part, the hardware construction of the entire image forming apparatus becomes complicated, resulting in an increased number of component parts and increased costs.

### SUMMARY OF THE INVENTION

The present invention provides an image forming apparatus with which operation-checking and an operation for clearing a counter value for a replaced component at component replacement can be performed with a simple manipulation and which is simple in construction and low in costs.

According to a first aspect of this invention, there is provided an image forming apparatus replaceably mounted with at least one roller component for recording sheet conveyance, which comprises a count unit adapted to count a number of times of use of the roller component, a detection unit adapted to detect an occurrence of conveyance jam during recording sheet conveyance by the roller component, a judgment unit adapted to alter a criterion value for detection of conveyance jam by the detection unit to a predetermined criterion value in a case where the roller component has been replaced and judge whether a conveyance jam has occurred based on the criterion value after alteration, and a control unit adapted to clear a counter value of the count unit in a case where it is determined by the judgment unit that a conveyance jam has not occurred.

According to a second aspect of this invention, there is provided an image forming apparatus replaceably mounted with at least one roller component for recording sheet feed, which comprises a count unit adapted to count a number of times of use of the roller component, a detection unit adapted to detect an occurrence of sheet feed jam during recording sheet feed by the roller component, a judgment unit adapted to alter a criterion value for detection of sheet feed jam by the detection unit to a predetermined criterion value in a case where the roller component has been replaced and judge whether a sheet feed jam has occurred based on the criterion value after alteration, and a control unit adapted to clear a counter value of the count unit in a case where it is determined by the judgment unit that a sheet feed jam has not occurred.

According to a third aspect of this invention, there is provided a control method for an image forming apparatus replaceably mounted with at least one roller component for recording sheet conveyance, which comprises a count step of counting a number of times of use of the roller component, a detection step of detecting an occurrence of conveyance jam during recording sheet conveyance by the roller component, a judgment step of altering a criterion value for detection of conveyance jam in the detection step to a predetermined criterion value in a case where the roller component has been replaced and judging whether a conveyance jam has occurred based on the criterion value after alteration, and a reset step of clearing a counter value representing the number of times of use of the roller component in a case where it is determined in the judgment step that a conveyance jam has not occurred.

According to a fourth aspect of this invention, there is provided a control method for an image forming apparatus replaceably mounted with at least one roller component for recording sheet feed, which comprises a count step of counting a number of times of use the roller component, a detection step of detecting an occurrence of sheet feed jam during recording sheet feed by the roller component, a judgment step of altering a criterion value for detection of sheet feed jam in the detection step to a predetermined criterion value in a case where the roller component has been replaced and judging whether a sheet feed jam has occurred based on the criterion value after alteration, and a reset step of clearing a count value representing the number of times of use of the roller component in a case where it is determined in the judgment step that a sheet feed jam has not occurred.

According to fifth and sixth aspects of this invention, there are provided computer-readable storage media each storing a program for causing a computer to execute the control method according to a corresponding one of the third and fourth aspects of this invention.

This invention is advantageous in that there can be provided an image forming apparatus with which operation-checking and an operation of clearing a counter value for a replaced component at component replacement can be performed with a simple manipulation, and which is simple in construction and low in costs.

Further features of the present invention will become apparent from the following description of an exemplary embodiment with reference to the attached drawings.

### BRIEF DESCRIPTION OF THE DRAWINGS

FIG. 1 is a block diagram schematically showing the construction of a control system of an image forming apparatus according to one embodiment of this invention;

FIG. 2 is a schematic view showing the hardware construction of the image forming apparatus;

FIG. 3 is a schematic view showing the construction of a recording-sheet-conveyance state detection unit disposed in a conveyance part of the image forming apparatus for successively drawing print sheets from upper and lower cassettes and conveying the print sheets along conveyance paths;

FIGS. 4A and 4B are views showing how a conveyance jam is detected by the recording-sheet-conveyance-state detection unit;

FIGS. 5A and 5B are views showing how a sheet feed jam at a feed roller is detected by the recording-sheet-conveyance-state detection unit;

FIG. 6 is a flowchart showing a roller operation-checking process performed by the image forming apparatus for operation-checking at roller replacement;

FIGS. 7A and 7B are views showing criterion values for jam detection and for operation-checking, which are used in the roller operation-checking process;

FIG. 8 is a view showing an example table for the roller operation-checking process;

FIGS. 9A and 9B are a flowchart showing the procedures of a new roller operation-checking process to determine whether a roller has been replaced with a new roller and reset the corresponding component counter value when replacement to a new roller is determined;

FIGS. 10A and 10B are views showing criterion values for the new roller operation-checking process;

FIG. 11 is a view showing a table for the new roller operation-checking process;

FIG. 12 is a view showing an example warning indication displayed when a new judgment criterion is not satisfied;

FIG. 13 is a view showing an example warning indication displayed upon occurrence of an error during the operation-checking process; and

FIG. 14 is a view showing an example warning indication displayed when the new component judgment criterion is not satisfied but the judgment criterion at normal operation is satisfied.

### DETAILED DESCRIPTION OF THE PREFERRED EMBODIMENT

The present invention will now be described in detail below with reference to the drawings showing a preferred embodiment thereof.

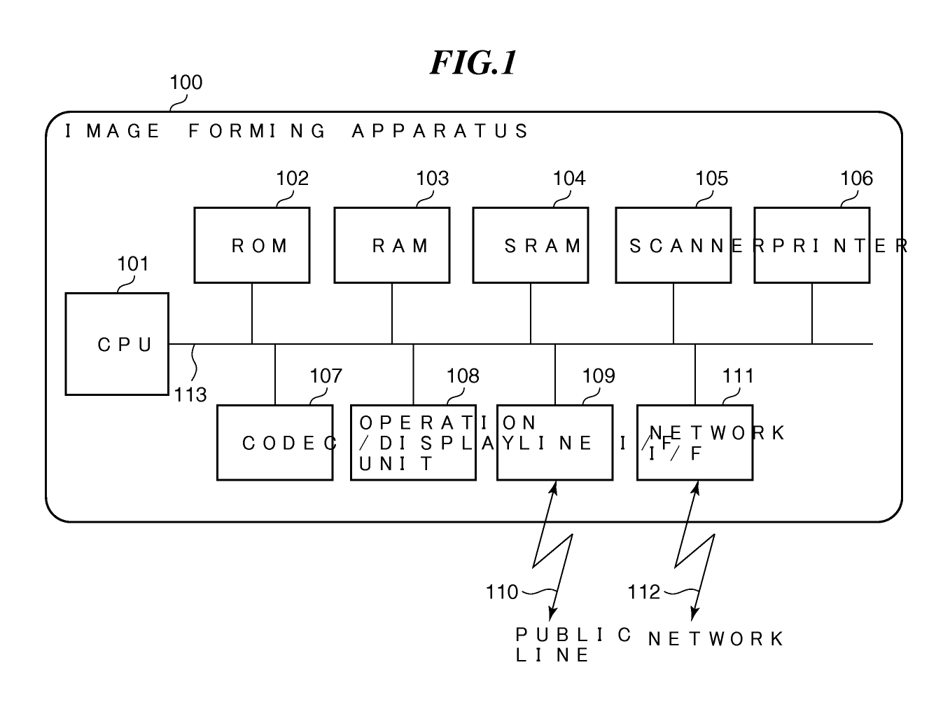

FIG. 1 schematically shows in block diagram the construction of a control system of an image forming apparatus according to one embodiment of this invention.

Referring to FIG. 1, reference numeral 100 denotes an image forming apparatus that includes a CPU 101, ROM 102, RAM 103, and SRAM 104. The CPU 101 functions as a system controller for controlling the entire image forming apparatus 100.

The ROM 102 stores a control program in accordance with which the CPU 101 executes various processing, described later, for detecting an operation state when recording sheets are fed and conveyed.

The RAM 103 stores an execution program, program control variables, work buffers, etc. The SRAM 104 stores setting values, management data, etc., registered by a user of the image forming apparatus 100.

The image forming apparatus 100 further includes a scanner 105, printer 106, CODEC 107, operation/display unit 108, line I/F 109, and network I/F 111, which are connected via a bus 113 to one another.

The scanner 105 is comprised of a CS image sensor, an original conveyance mechanism, etc., and adapted to optically read an original and convert read data into electrical image data.

The printer 106 is adapted to record reception data or file data on a recording sheet.

The CODEC 107 is a module for JBIC/JPEG encoding and decoding, etc., and performing processing to compress and decompress image data according to predetermined standard.

The operation/display unit 108 is comprised of a keyboard, touch panel, LCD, LEDs, etc., and operable by an apparatus user for various operations and adapted to display a notification to the user.

The line I/F 109 is comprised of a modem (modulator-demodulator), an NCU (network control unit), etc., and adapted to carry out FAX transmission/reception via a public line 110.

The network I/F 111 is configured to transmit and receive an e-mail, various data via a network 112.

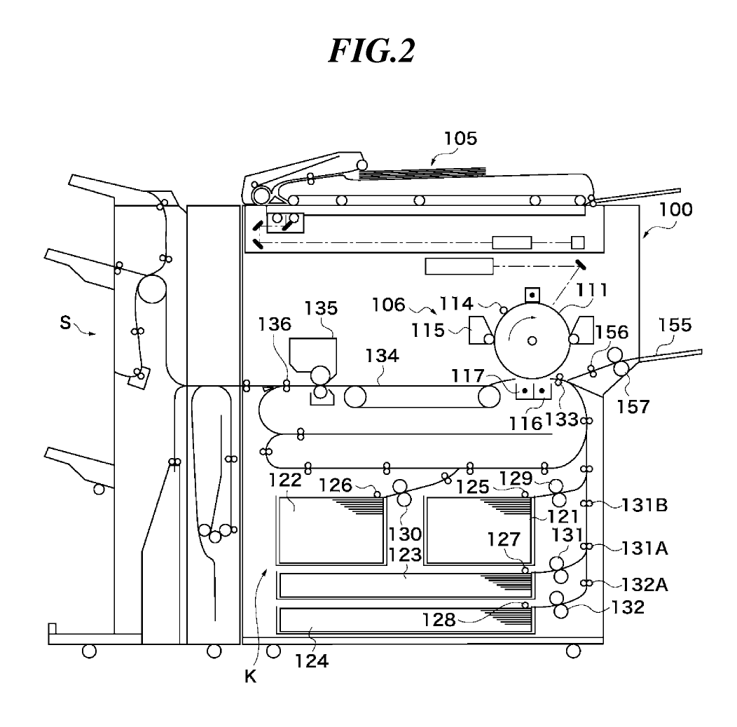

Next, with reference to FIG. 2, the hardware construction of the image forming apparatus 100 is described.

FIG. 2 schematically shows the hardware construction of the image forming apparatus 100 in which the scanner 105 is disposed at its upper part, the printer 106 is disposed at a middle part, a sheet feed unit K is disposed at a lower part, and a sorter unit (print discharge unit) S is disposed at one side part thereof.

The sheet feed unit K is removably mounted with right, left, upper and lower cassettes 121-124 in which print sheets are placed in stack.

Print sheets (recording sheets) in the cassettes 121-124 are successively drawn out for conveyance to the printer 106 by respective ones of feed rollers 125-128 replaceably mounted to the image forming apparatus 100.

Print sheets delivered from the sheet feed unit K are conveyed to the printer 106 along a conveyance path by respective ones of conveyance rollers 129-133 replaceably mounted to the image forming apparatus 100. The apparatus 100 is further provided with a multiple manual feed tray 155 able to hold one hundred sheets. Print sheets delivered from the tray 155 are successively conveyed to the printer 106 by conveyance rollers 157, 156 and 133.

The printer 106 performs an electrophotographic image formation process to form a toner image on a surface of the photosensitive drum 111, while conveying a print sheet by a transfer belt 134. The toner image formed on the drum 111 is transferred onto the print sheet by a transfer charger 116.

After the toner image transfer, residual toners and residual electric charges remaining on the drum 111 are removed by a cleaner device 115 and a pre-exposure lamp 114, respectively.

The print sheet on which the toner image has been transferred is separated from the drum 111 by a separation charger 117 and conveyed by the transfer belt 134 to a fixing device 135.

In the fixing device 135, the print sheet on which the toner image has been transferred is applied with pressure and heat, thereby fixing the toner image onto the print sheet, which is then discharged by discharge rollers 136 to a sorter unit S outside the apparatus 100.

At a conveyance part of the image forming apparatus 100 that conveys a print sheet (recording sheet) drawn from the sheet feed unit K, a recording-sheet-conveyance-state detection unit (hereinafter sometimes referred to as the conveyance-state detection unit or detection unit) for detecting an operation state when the print sheet is conveyed is disposed.

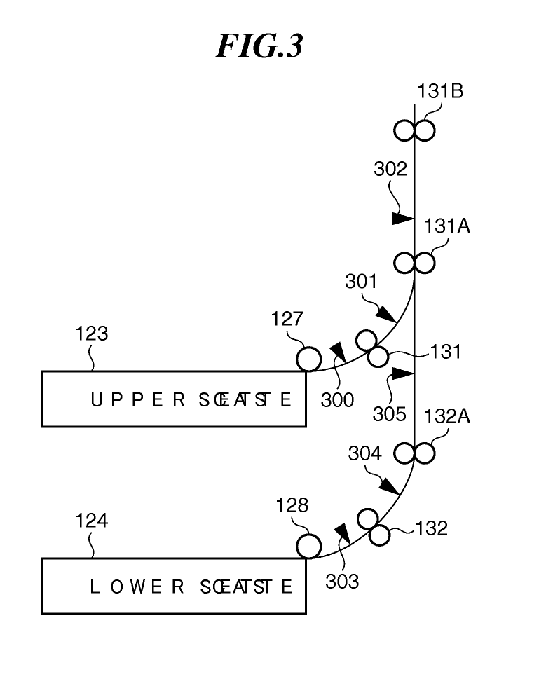

FIG. 3 schematically shows the construction of the detection unit disposed in the conveyance part of the image forming apparatus 100 that draws print sheets (recording sheets) from the upper and lower cassettes 123, 124 and conveys the sheets along conveyance paths.

As shown in FIG. 3, a feed roller 127 for drawing a print sheet from the upper cassette 123 is replaceably mounted to the image forming apparatus 100. Conveyance roller pairs 131, 131A and 131B are disposed at predetermined distances relative to one another along a conveyance path extending from the feed roller 127 to the printer 106.

First to third sensors 300 to 302 for print sheet detection are disposed at three predetermined positions along the conveyance path extending from the feed roller 127 to the printer 106, whereby sheet conveyance times at positions upstream and downstream of the conveyance rollers 131, 131A can be measured.

Specifically, the first sensor 300 is disposed at a predetermined position between the feed roller 127 and the conveyance rollers 131, the second sensor 301 is disposed at a predetermined position between the conveyance rollers 131 and 131A, and the third sensor 302 is disposed at a predetermined position between the conveyance rollers 131A and 131B.

Similarly, on the side of the lower cassette 124, a feed roller 128 for drawing a print sheet from the cassette 124 is replaceably mounted to the apparatus 100, and conveyance roller pairs 132, 132A and 131A are disposed at predetermined distances along a conveyance path extending from the feed roller 128 to the printer 106. The conveyance rollers 131A are common to the conveyance paths on the upper cassette 123 side and the lower cassette 124 side.

First to third sensors 303 to 305 for print sheet detection are disposed at three predetermined positions along the conveyance path extending from the feed roller 128 to the printer 106.

Specifically, the first sensor 303 is disposed at a predetermined position between the feed roller 128 and the conveyance rollers 132, the second sensor 304 is disposed at a predetermined position between the conveyance rollers 132 and 132A, and the third sensor 305 is disposed at a predetermined position between the conveyance rollers 132A and 131A.

The sensors 300 to 305 are each configured to detect the presence/absence of a print sheet. Preferably, similar sensors are disposed along conveyance paths extending from the right and left cassettes 121, 122 of the sheet feed unit K to the printer 106. These sensors constitute the recording-sheet-conveyance-state detection unit that measures times in each of which the leading end of a print sheet reaches a corresponding one of the predetermined positions on the conveyance paths of the sheet feed unit K. The detection unit has a function of detecting a feed jam or a conveyance jam of a recording sheet (print sheet) to thereby detect a sheet conveyance state.

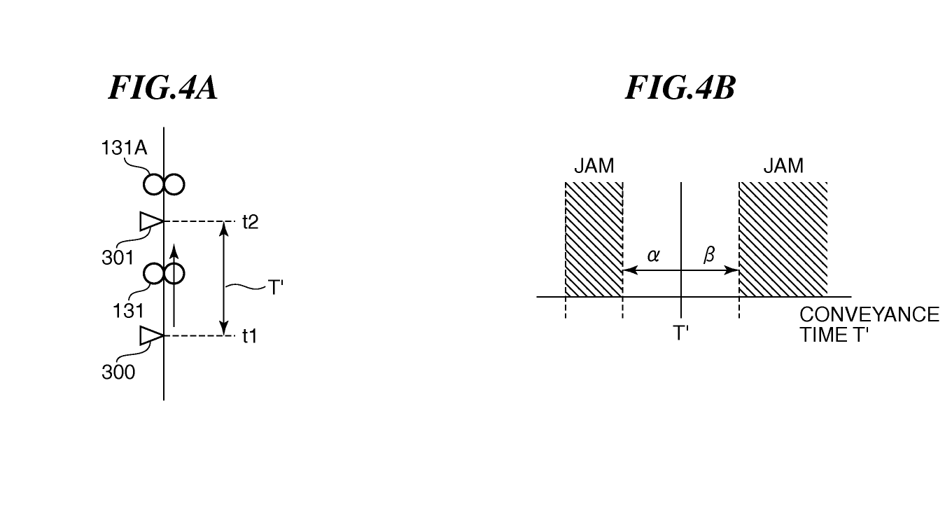

Next, with reference to FIGS. 4A and 4B, a description will be given of how a conveyance jam is detected by the conveyance-state detection unit in FIG. 3.

FIGS. 4A and 4B show how a conveyance jam is detected by the conveyance-state detection unit.

The detection unit measures a recording sheet conveyance time in each of sections between adjacent predetermined positions in the conveyance paths extending from the sheet feed unit K to the printer 106. For example, while a print sheet is conveyed along the conveyance path by the conveyance rollers 131 and 131A as shown in FIG. 4A, the first and second sensors 300, 301 detect times t1, t2 in which the leading end of the print sheet passes through these sensors, and transmit detection signals to the CPU 101 as the system controller. The CPU 101 calculates a difference between the times t1, t2 detected by the sensors 300, 301 to thereby detect a conveyance time T′.

In the conveyance jam detection, each time one print sheet is conveyed along one of the conveyance paths extending from the sheet feed unit K, a sheet conveyance time in each section of the transfer path, e.g., the conveyance time T′ in FIG. 4A, is measured and compared with a predetermined conveyance time T. When determining that the measured conveyance time T′ falls outside a range from T−a to T+β, the CPU 101 (system controller) determines an occurrence of a conveyance jam, stops the image formation operation, and provides a jam indication on the operation/display unit 108. The measured conveyance time T′ less than T−a indicates an early jam, whereas the measured conveyance time T′ longer than T+β indicates a delay jam.

In the conveyance jam detection, a criterion value for conveyance detection (the range from T−a to T+β in this example) is used, which is variably set in advance and readably stored in a storage unit (ROM 102, RAM 103, SRAM 104 or the like) for the system controller of the image forming apparatus 100.

In the image forming apparatus 100, the criterion value for jam detection is made changeable to a new component judgment criterion value for conveyance roller component. The new component judgment criterion value (a range varying from T−a′ to T+β′ in this example) can be stored in the storage unit for the system controller and read out therefrom. Alternatively, the new component judgment criterion value can be set by replacing a and B of the criterion value by a′ and β′.

The following is a description of the reason why whether a conveyance roller component has been replaced by a new component can be determined by substituting the criterion value for conveyance jam detection with the new component judgment criterion value.

In the image forming apparatus 100, the prescribed value T of conveyance time is determined according to the conveyance speed by the conveyance roller or roller pair (hereinafter referred to as the roller in some cases) and the distance between the first and second sensors 300, 301. However, with the increase in the number of times of use of the conveyance roller, the conveyance roller is gradually worn away, resulting in a variation in conveyance time.

If a print sheet conveyance time detected by the conveyance-state detection unit is consistent with that detected when a new conveyance roller is used, it can be determined that the replacement to a new conveyance roller has been made. Based on the conveyance time detected by the detection unit, it is therefore possible to determine whether the conveyance roller has been replaced by a new one. Accordingly, a conveyance time attained when a new conveyance roller is used is determined in advance by, e.g., experiment and set as a new component judgment criterion value for conveyance roller component (a criterion value after alteration). It is empirically known that the new component judgment criterion value for conveyance roller component nearly equals to the prescribed value T of conveyance time.

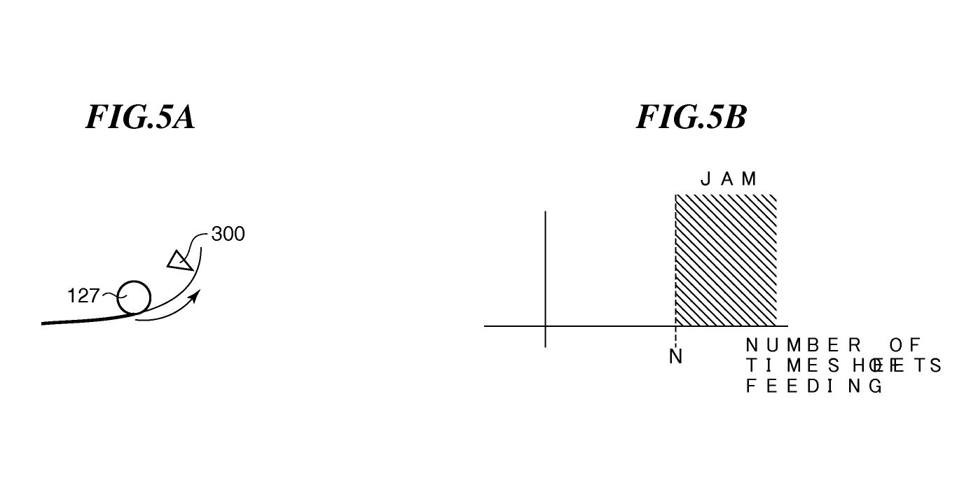

Next, a description is given of how a sheet feed jam is detected by the conveyance-state detection unit with reference to FIGS. 5A and 5B. The sheet feed jam detection is utilized to determine whether the replacement to a new feed roller has been made.

FIGS. 5A and 5B show how a sheet feed jam at a feed roller is detected by the conveyance-state detection unit.

As shown in FIG. 5, in the sheet feed jam detection, a time period from when a sheet feed operation is started by rotatably driving the feed roller 127 to when the leading end of a print sheet reaches the first sensor 300 is detected. Specifically, the system controller calculates a difference between the time when the feed roller 127 is started to be driven and the time when the first sensor 300 detects the leading end of a print sheet, thereby detecting a sheet feed time.

If the print sheet does not reach the first sensor 300 before elapse of a predetermined time period, the system controller drives the feed roller 127 for a sheet-refeeding operation. In a case that the print sheet does not reach the first sensor 300 even if the sheet-refeeding operation is repeated a predetermined number of times N, the system controller determines that a sheet feed jam has occurred, stops the image formation operation, and provides a jam indication on the operation/display unit.

In the sheet feed jam detection, a criterion value for sheet-feed jam detection (the number of execution times N of sheet-refeeding operation in this example) is used, which is variably set in advance and readably stored in the storage unit (ROM 102, RAM 103, SRAM 104, or the like) for the system controller of the image forming apparatus 100.

In the image forming apparatus 100, the criterion value for sheet-feed jam detection (criterion value before alteration) is made changeable to a new component judgment criterion value for sheet-feed roller component (criterion value after alteration). The new component judgment criterion value for sheet-feed roller component (N′ in this example) can be stored in the storage unit for the system controller and read out therefrom.

The following is a description of the reason why whether a sheet-feed roller component has been replaced by a new component can be determined by substituting the criterion value for sheet-feed jam detection with a new component judgment criterion value.

In the image forming apparatus 100, a sheet-feed roller is gradually worn out and the friction coefficient of roller surface decreases with the increase in the number of times of use of the sheet-feed roller, resulting in a tendency that the degree of necessity of sheet-refeeding increases and the number of execution times of sheet-refeeding increases.

If a sheet-refeeding operation state detected by the conveyance-state detection unit is consistent with that of when a sheet is refed by a new feed roller, replacement to the new feed roller can be determined. Based on the detected sheet-refeeding operation state, it is therefore possible to determine whether the feed roller has been replaced by a new one. Thus, the number of execution times of sheet-refeeding when a new feed roller is used is determined beforehand by, e.g., experiment and set as a new component judgment criterion value for feed roller component. It is empirically known that the new component judgment criterion value nearly equals to the prescribed value N (once in this example) of the number of execution times of sheet feeding operation (sheet refeeding) to feed one print sheet.

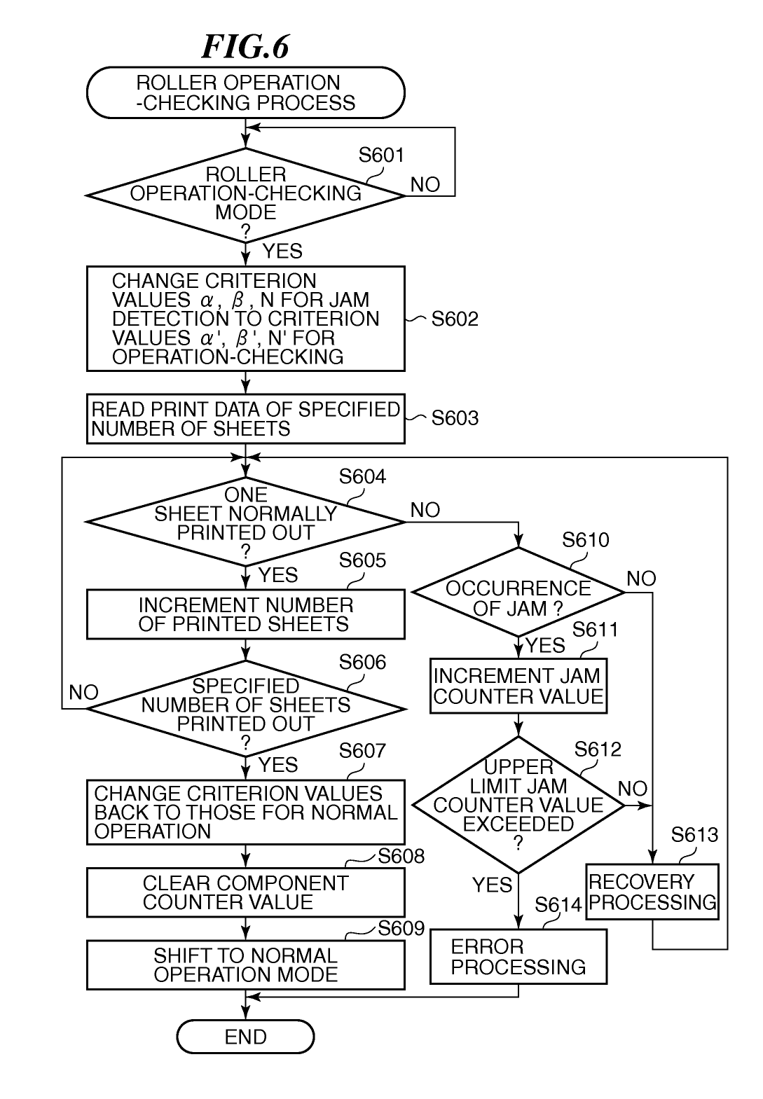

Next, with reference to FIG. 6, a description will be given of the procedures for operation-checking at roller replacement, which are based on conveyance time and conveyance state detected by the conveyance-state detection unit.

FIG. 6 shows in flowchart a roller operation-checking process performed by the image forming apparatus 100 for operation-checking at roller replacement.

The CPU 101 of the image forming apparatus 100 determines whether an instruction to shift to a roller operation-checking mode is given by a user by operating the operation/display unit 108 (step S601). If the user's instruction to shift to the operation-checking mode is not given (No to step S601), the CPU 101 waits for the user's instruction.

When the user's instruction to shift to the roller operation-checking mode is given (YES to step S601), the process proceeds to the next step S602.

In step S602, the CPU 101 changes the settings for sheet feed jam detection and conveyance jam detection to the settings for detection of operation states of conveyance roller and feed roller. Specifically, a setting alteration processing is carried out to change criterion values for jam detection to those for operation-checking.

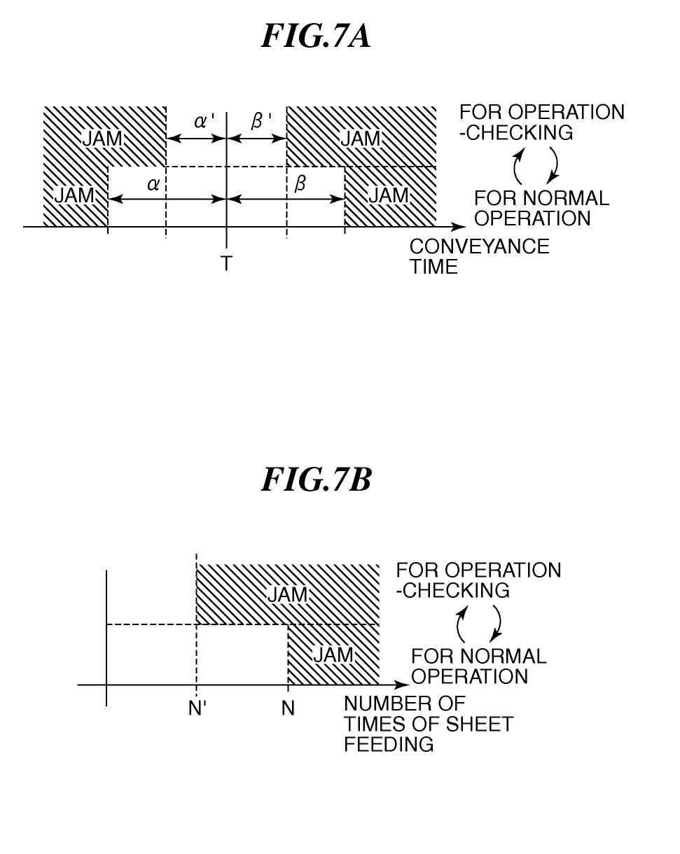

In the setting alteration processing, as shown in FIG. 7A, criterion values a, β for conveyance jam detection are changed to new component judgment criterion values a′, β′ for conveyance roller component, which are smaller than the values a, β.

As shown in FIG. 7B, a criterion value N for sheet feed jam detection is also changed to a new component judgment criterion value N′ for sheet feed roller component, which is smaller than the value N. This is because, since a new roller is not worn and hence relevant conveyance time and number of execution times of sheet-refeeding become close to design values, the criterion values a, β and N (e.g., 50 msec, 100 msec and 3) for jam detection at normal operation are changed to smaller criterion values a′, β′ and N′ (e.g., 30 msec, 50 msec and 1) for operation-checking, which must be performed under a more strict condition than that under which the normal operation is performed.

In the roller operation-checking mode, the CPU 101 reads print data of a specified number of sheets for which the operation-checking must be made, and then starts a printing operation (step S603). The number of sheets for which the operation-checking must be made is an arbitrary number equal to or greater than one, which may be a fixed number or may be set by the user by operating the operation/display unit 108.

Upon completion of the printing of print data of one sheet, the CPU 101 determines whether the print data has normally been printed out (step S604).

When determining that the print data has normally been printed out (YES to step S604), the CPU 101 increments the number of printed sheets by one (step S605).

When determining that the print data of the specified number of sheets read out in step S603 has not been printed out (NO to step S606), the CPU 101 returns to step S604. The CPU proceeds to step S607 when determining that all the print data of the specified number of sheets has been printed out (YES to step S606).

In step S607, the CPU 101 changes the criterion values a′, β′ and N′ for operation-checking back to the criterion values a, β and N for jam detection at normal operation.

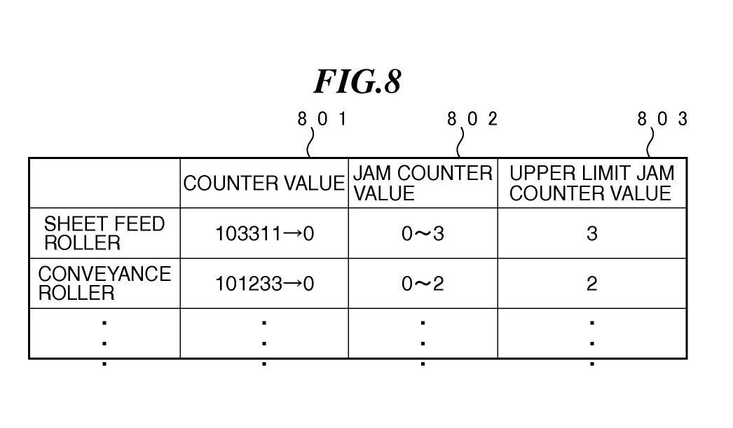

Next, the CPU 101 clears the counter value of a corresponding one of component counters (shown at 801 in FIG. 8) to thereby reset the counter value to an initial value (step S608).

Then, the CPU 101 makes a shift to a normal operation mode (step S609) and completes the roller operation-checking process.

If it is determined in step S604 that the printing of print data of one sheet has not been completed normally (NO to step S604), the CPU 101 determines whether the printing failure is caused by a jam (step S610).

When determining that the printing failure is caused by a jam (YES to step S610), the CPU 101 proceeds to step S611 to increment a corresponding one of jam counter values (shown at 802 in FIG. 8). Jam counters are provided to correspond to respective ones of replaceable rollers and configured to make counting operations independently of one another.

Next, the CPU 101 compares the jam counter value with a corresponding one of upper limit jam counter values (shown at 803 in FIG. 8) to thereby determine whether the jam counter value exceeds the upper limit jam counter value (step S612). When it is determined that the jam counter value exceeds the upper limit (YES to step S612), the CPU 101 carries out error processing (step S614) and then completes the roller operation-checking process.

When it is determined in step S610 that the printing failure is not caused by a jam or when it is determined in step S612 that the jam counter value does not exceed the upper limit, the CPU 101 carries out recovery processing (step S613). In the recovery processing, a printing operation is performed again from a page not printed out normally in the previous printing. To this end, the cause of and countermeasure for the previous printing failure are displayed to prompt the user to take necessary actions. For example, when print sheets are run out, indication to prompt the user to refill print sheets is displayed. When a jam has occurred, indication to prompt the user to remove a jammed sheet is displayed. If the cause of printing failure is removed, the CPU 101 proceeds to step S604 to restart the printing operation from a page not printed out normally in the previous printing.

Next, a table used for the roller operation-checking process in FIG. 6 is described with reference to FIG. 8.

FIG. 8 shows an example table for the roller operation-checking process in FIG. 6.

The table can be stored in the ROM 102, RAM 103, or SRAM 104 of the image forming apparatus 100 and can be read and written by the CPU 101.

Component counters (life counters for measurement of component service lives) are adapted to indicate the frequencies of use of rollers. Counter values 801 in FIG. 8 are each incremented by one each time a corresponding roller is used. Each component counter has a function of detecting the arrival at replacement time of the roller when the counter value reaches a predetermined value indicating that the roller service life comes to an end.

Each component counter value 801 is cleared to be reset to zero in step S608 of FIG. 6 when it is determined in the operation-checking process that the replaced roller is normal.

Jam counter values 802 in the table are each incremented in step S611 each time a jam occurs in the roller operation-checking process of FIG. 6, and are cleared to zero at start of the roller operation-checking process.

When a jam occurs in the roller operation-checking process, a corresponding one of upper limit jam counter values 803 in the table is referred to in step S612 to determine whether the operation-checking process should be continued or the error processing should be performed. Each upper limit jam counter value 803 is an arbitrary integer number which is equal to or greater than one, which may be a fixed number suitable for each roller type or may be set by the user by operating the operation/display unit 108.

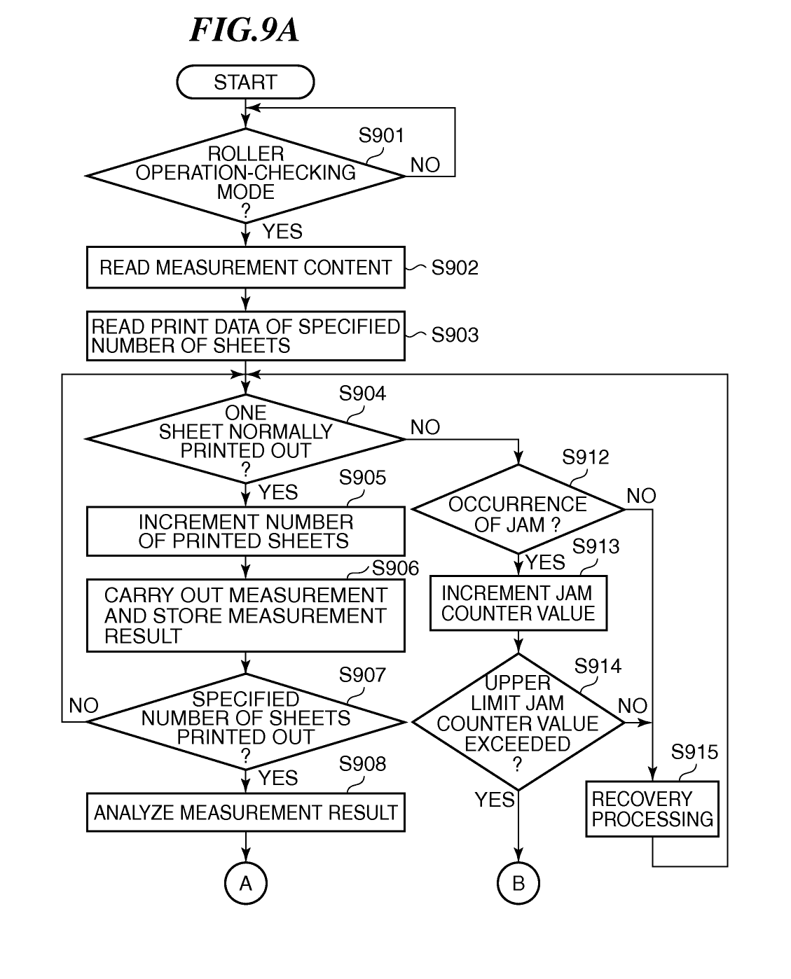

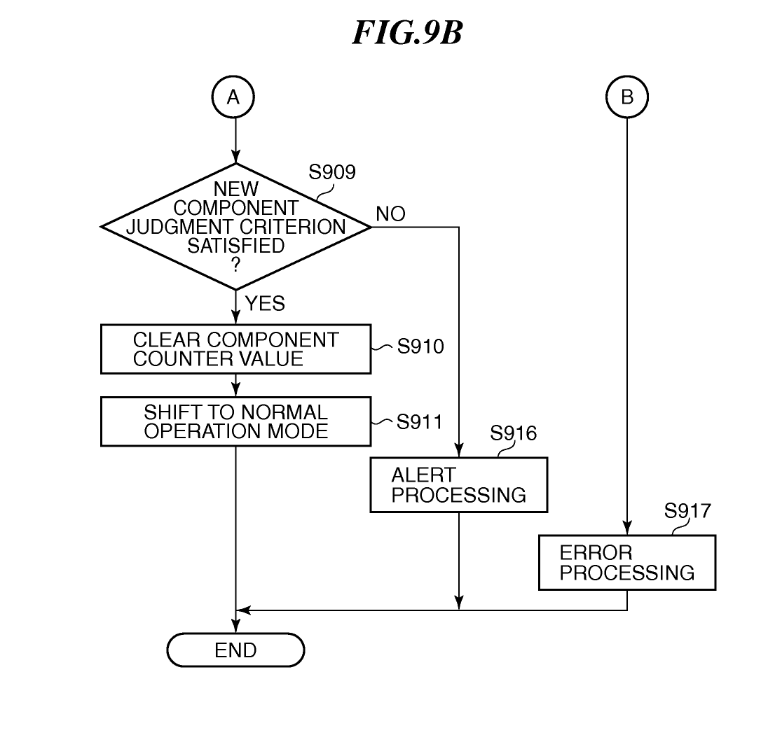

Next, with reference to FIGS. 9A and 9B, a description is given of the procedures to determine whether a roller has been replaced with a new roller based on a roller operation state detected by the conveyance-state detection unit and to reset the corresponding component counter value when replacement to a new roller is determined.

FIGS. 9A and 9B show in flowchart the procedures of a new roller operation-checking process in which whether a roller has been replaced with a new roller is determined and the corresponding component counter value is reset when replacement to a new roller is determined.

The CPU 101 of the image forming apparatus 100 determines whether an instruction to shift to a roller operation-checking mode is given by a user by operating the operation/display unit 108 (step S901). If the user's instruction is not given (No to step S901), the CPU 101 waits for reception of the user's instruction.

When the instruction to shift to the roller operation-checking mode is given by the user (YES to step S901), the process proceeds to the next step S902.

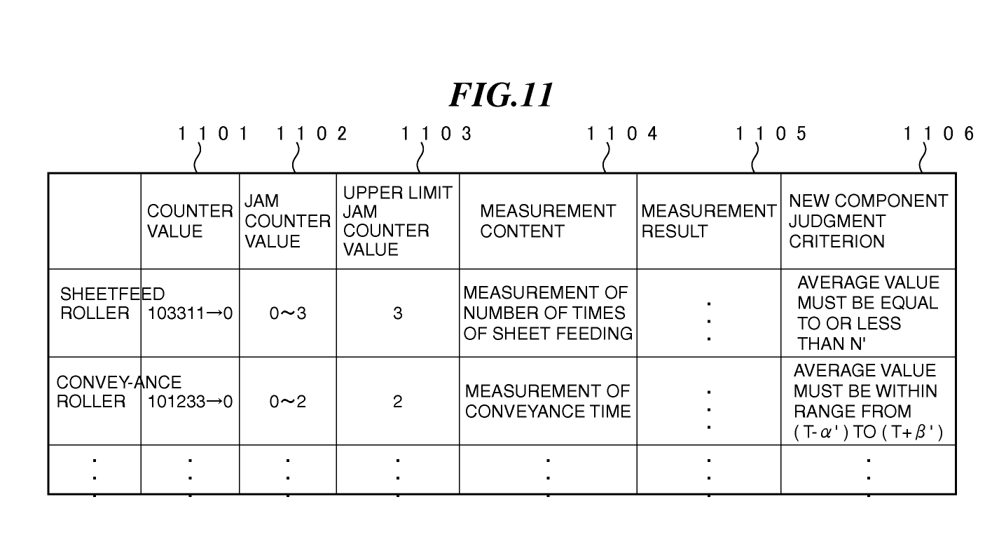

In step S902, the CPU 101 reads a corresponding one of measurement contents (shown at 1104 in FIG. 11). In the case of feed roller replacement, the number of repetition (execution times) of sheet-refeeding will be measured. In the case of conveyance roller replacement, conveyance time will be measured.

In the roller operation-checking mode, the CPU 101 reads print data of a specified number of sheets for which the operation-checking must be made and then starts a printing operation (step S903). The number of sheets for which the operation-checking must be made is an arbitrary number equal to or greater than one, which may be a fixed number or may be set by the user by operating the operation/display unit 108.

Upon completion of the printing of print data of one sheet, the CPU 101 determines whether the print data has normally been printed out (step S904).

When determining that the data has normally been printed out (YES to step S904), the CPU 101 increments the number of printed sheets by one (step S905). Then the CPU 101 carries out a measurement in accordance with the measurement content read in step S902, and a result of the measurement is stored as shown at 1105 in FIG. 11 (step S906).

When determining that the print data of the specified number of sheets read out in step S903 has not been printed out (NO to step S907), the CPU 101 returns to step S904. The CPU proceeds to step S908 when determining that all the print data of the specified number of sheets has been printed out (YES to step S907).

Based on the corresponding new component judgment criterion (shown at 1106 in FIG. 11), the CPU 101 analyzes the measurement result shown at 1105 in FIG. 11 (step S908).

In the case of feed roller replacement, the CPU 101 determines that the new component judgment criterion is satisfied, if an average value of the numbers of times of sheet-feeding (average value of numbers of execution times of sheet-refeeding) measured for the specified number of sheets is equal to or less than a new component judgment criterion value N′. In the case of conveyance roller replacement, the CPU 101 determines that the new component judgment criterion is satisfied, if an average value of measured conveyance times falls within a range from T−a′ to T+β′.

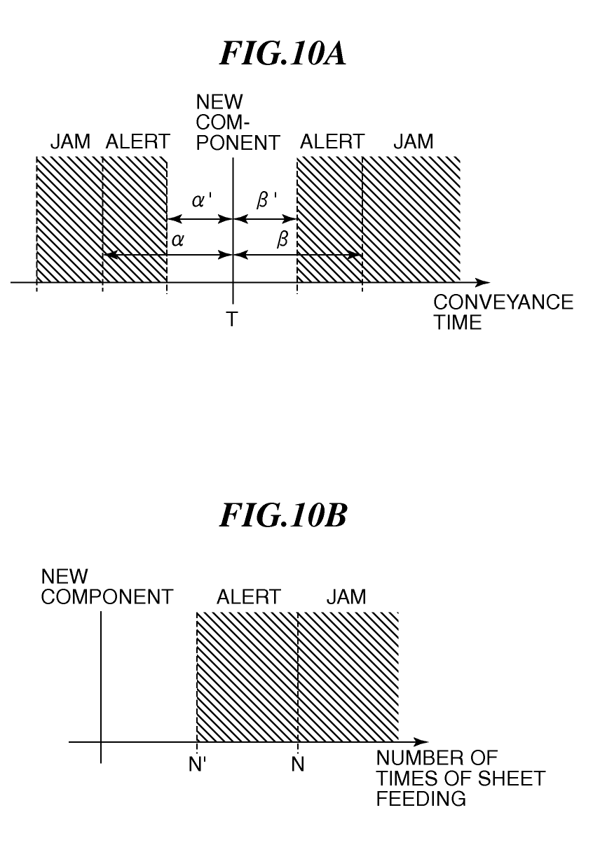

In this embodiment, new component judgment criterion values a′, β′, N′ are set to be smaller than criterion values a, β, N for jam detection at normal operation as shown by way of example in FIGS. 10A and 10B, thereby performing the new component judgment under a more strict condition than that under which the normal operation is performed. For example, the criterion values a, β, N are set to 50 msec, 100 msec and 3, whereas the new component judgment criterion values a′, β′, N′ are set to 30 msec, 50 msec and 1, respectively.

When determining that the new component judgment criterion is satisfied (YES to step S909), the CPU 101 determines that the roller replacement has been made normally, and proceeds to step S910 to clear the component counter value shown at 1101 in FIG. 1101. Then, the CPU 101 makes a shift to a normal operation mode (step S911) and completes the new roller operation-checking process.

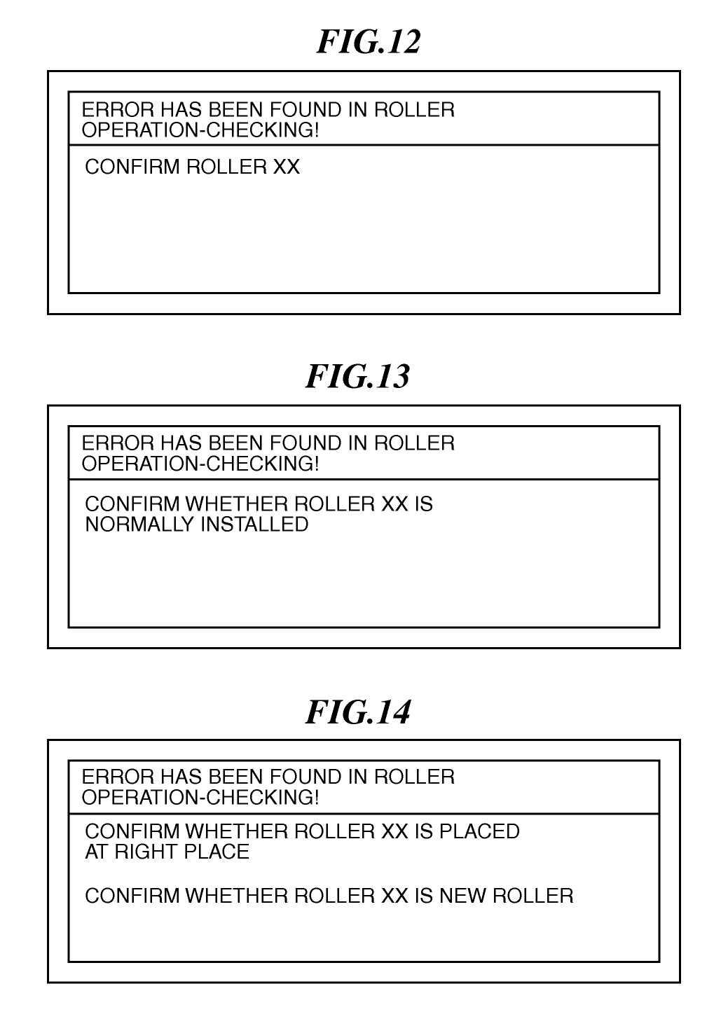

If it is determined in step S909 that the new component judgment criterion is not satisfied (NO to step S909), the CPU 101 carries out alert processing to provide a warning indication as shown by way of example in FIG. 12 (step S916).

The warning indication in FIG. 12 prompts the user to confirm the replaced roller. If the result of the determination in step S909 is negative (NO), it indicates that the replaced roller does not satisfy the new component judgment criterion, but satisfies the jam judgment criterion at normal operation and a printing operation can therefore be normally performed. In that case, an indication that there is a fear that the replaced roller is placed at a wrong place or the replaced roller is a not-new roller can be displayed. For example, as shown in FIG. 14, the warning indication may prompt the user to confirm the place in which the replacement roller has been placed and confirm whether the replacement roller is a new roller.

If it is determined in step S904 that the printing of print data of one sheet has not been normally completed (NO to step S904), the CPU 101 determines whether the printing failure is caused by a jam (step S912).

When determining that the printing failure is caused by a jam (YES to step S912), the CPU 101 proceeds to step S913 to increment a corresponding one of jam counter values (shown at 1102 in FIG. 11). Jam counters are provided to correspond to respective ones of replaceable rollers and configured to make counting operations independently of one another.

Next, the CPU 101 compares the jam counter value with the corresponding upper limit jam counter value (shown at 1103 in FIG. 11) to thereby determine whether the jam counter value exceeds the upper limit jam counter value (step S914). When it is determined that the jam counter value exceeds the upper limit (YES to step S914), the CPU 101 carries out error processing (step S917) and then completes the roller operation-checking process. Each upper limit jam counter value is an arbitrary integer number which is equal to or greater than one, which may be a fixed number suitable for each roller type or may be set by the user by operating the operation/display unit 108.

In the error processing in step S917, the indication shown in FIG. 12 is displayed on the operation/display unit 108 to notify the user that an error has occurred during the operation-checking. If the result of the determination in step S914 becomes NO, it indicates that a jam has frequently occurred during the operation-checking under the same judgment criterion as that for normal operation. In that case, an indication can be displayed as shown in FIG. 13 that there is a fear that a roller replacement operation per se such as roller installation has not normally been performed.

When it is determined in step S912 that the printing failure is not caused by a jam or when it is determined in step S914 that the jam counter value does not exceed the upper limit, the CPU 101 carries out recovery processing (step S915). In the recovery processing, a printing operation is performed again from a page not printed out normally in the previous printing. To this end, the cause of and countermeasure for the previous printing failure are displayed to prompt the user to take necessary actions. If the cause of printing failure is removed, the CPU 101 proceeds to step S904 to restart a printing operation from a page not printed out normally in the previous printing.

As described above, the new roller operation-checking process in FIGS. 9A and 9B makes it possible to notify the user of the cause of and countermeasure for an error occurred during the operation-checking in more detail than in the roller operation-checking process in FIG. 6. For example, an indication can be displayed as shown in FIG. 13 that there is a fear that a roller replacement operation per se such as roller installation has not been normally performed, or an indication can be displayed as shown in FIG. 14 that there is a fear that the replaced roller has been placed at a wrong place or the replacement roller is a not-new roller.

With the new roller operation-checking process, in accordance with a user's simple manipulation, it is possible to determine whether a replaced component is a new component and reset a counter value for a replaced component determined to be new at component replacement in the image forming apparatus. It is also possible to confirm whether the component replacement has normally been made and the replaced component normally operates.

FIG. 11 shows an example table for the new roller operation-checking process in FIGS. 9A and 9B. The table can be stored in the ROM 102, RAM 103, or SRAM 104 of the image forming apparatus 100 and can be read and written by the CPU 101.

As shown in FIG. 11, the table includes items of component counter value 1101, jam counter value 1102, upper limit jam counter value 1103, measurement content 1104, measurement result 1105, and new component judgment criterion 1106.

Component counters indicate the frequencies of use of rollers. Counter values 1101 in FIG. 11 are each incremented by one each time the corresponding roller is used and are each cleared to be reset to zero in step S910 of FIG. 9B when the corresponding replaced roller is determined to be normal in the operation-checking process.

Jam counter values 1102 are each incremented in step S913 each time a jam occurs in the roller operation-checking process of FIGS. 9A and 9B, and are cleared to zero at start of this process.

Upper limit jam counter values 1103 are each referred to in step S914 when a jam takes place during the roller operation-checking process, to determine whether this process should be continued or the error processing should be performed. Each upper limit jam counter value 1103 is an arbitrary integer number which is equal to or greater than one, which may be a fixed number suitable for each roller type or may be set by the user by operating the operation/display unit 108.

Measurement contents 1104 are set in advance for respective ones of roller types. For example, a measurement content for feed roller is set to specify a measurement of the number of times of sheet-feeding (the number of execution times of sheet-refeeding), and a measurement content for conveyance roller is set to specify a measurement of conveyance time.

In each of measurement results 1105, a result of measurement performed according to the measurement content 1104 is stored, which is obtained in step S906 in the roller operation-checking process at each printing of print data of one sheet.

Each of new component judgment criterions 1106 is set according to the corresponding measurement content 1104 for use in the determination in step S909 as to whether the new component judgment criterion is satisfied. For example, for the measurement content 1104 that specifies a measurement of the number of times of sheet feeding (the number of execution times of sheet-refeeding), the new component judgment criterion 1106 is that an average value of measurement results 1105 must be equal to or less than N′. For the measurement content 1104 that specifies a measurement of conveyance time, the new component judgment criterion 1106 is that an average value of measurement results 1105 must be within a range from T−a′ to T+β′.

As described above, in this embodiment, as the hardware construction of a judgment unit for determining whether a replaced roller is a new roller, the recording-sheet-conveyance-state detection unit, i.e., the existing construction of the image forming apparatus is used that detects an operation state at the time of print sheet conveyance.

When the conveyance-state detection unit is used as the judgment unit, the existing function of the detection unit to detect the sheet conveyance state is changed to a new roller judgment function. Specifically, criterion values for conveyance jam detection and/or sheet feed jam detection are changed to new component judgment criterion values, which are close to prescribed values representing a designed sheet conveyance state and/or a designed sheet feed state.

As described above, the image forming apparatus of this embodiment additionally comprises the new roller judgment function achieved by utilizing the existing hardware construction. Thus, a low-priced, intelligent image forming apparatus can be provided without the need of adding new components.

It is to be understood that the present invention may also be accomplished by supplying a system or an apparatus with a storage medium in which a program code of software, which realizes the functions of the above described embodiment is stored and by causing a computer (or CPU or MPU) of the system or apparatus to read out and execute the program code stored in the storage medium. In that case, the program code itself read from the storage medium realizes the functions of the above described embodiment, and therefore the program code and the storage medium in which the program code is stored constitute the present invention.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

Examples of the storage medium for supplying the program code include a floppy (registered trademark) disk, a hard disk, and a magnetic-optical disk, a CD-ROM, a CD-R, a CD-RW, a DVD-ROM, a DVD-RAM, a DVD−RW, a DVD+RW, a magnetic tape, a nonvolatile memory card, and a ROM. The program code may be downloaded via a network.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2008-163669, filed Jun. 23, 2008, which is hereby incorporated by reference herein in its entirety.

What is claimed is:

1. An image forming apparatus replaceably mounted with at least one roller component for recording sheet conveyance, comprising:
a count unit adapted to count a number of times of use of the roller component;
a detection unit adapted to detect an occurrence of conveyance jam during recording sheet conveyance by the roller component;
a judgment unit adapted to alter a criterion value for detection of conveyance jam by said detection unit to a predetermined criterion value in a case where the roller component has been replaced and judge whether a conveyance jam has occurred based on the criterion value after alteration; and
a control unit adapted to clear a counter value of said count unit in a case where it is determined by said judgment unit that a conveyance jam has not occurred.

2. The image forming apparatus according to claim 1, wherein said detection unit is configured to measure a sheet conveyance time in a conveyance path extending from a position upstream of the roller component to a position downstream thereof.

3. The image forming apparatus according to claim 1, wherein in a case where it is determined by said judgment unit that a conveyance jam has not occurred, the criterion value for the detection of conveyance jam is changed from the criterion value after alteration back to the criterion value before alteration.

4. The image forming apparatus according to claim 1, wherein the predetermined criterion value is used to determine whether the roller component is a new roller component.

5. An image forming apparatus replaceably mounted with at least one roller component for recording sheet feed, comprising:
a count unit adapted to count a number of times of use of the roller component;
a detection unit adapted to detect an occurrence of sheet feed jam during recording sheet feed by the roller component;
a judgment unit adapted to alter a criterion value for detection of sheet feed jam by said detection unit to a predetermined criterion value in a case where the roller component has been replaced and judge whether a sheet feed jam has occurred based on the criterion value after alteration; and
a control unit adapted to clear a counter value of said count unit in a case where it is determined by said judgment unit that a sheet feed jam has not occurred.

6. The image forming apparatus according to claim 5, wherein said detection unit is adapted to measure a number of times of sheet-refeeding by the roller component.

7. The image forming apparatus according to claim 5, wherein the predetermined criterion value indicates a number of times of sheet-feeding which is once.

8. The image forming apparatus according to claim 5, wherein in a case where it is determined by said judgment unit that a sheet feed jam has not occurred, the criterion value for the detection of sheet feed jam is changed from the criterion value after alteration back to the criterion value before alteration.

9. The image forming apparatus according to claim 5, wherein the predetermined criterion value is used to determine whether the roller component is a new roller component.

10. A control method for an image forming apparatus replaceably mounted with at least one roller component for recording sheet conveyance, comprising:
a count step of counting a number of times of use of the roller component;
a detection step of detecting an occurrence of conveyance jam during recording sheet conveyance by the roller component;
a judgment step of altering a criterion value for detection of conveyance jam in said detection step to a predetermined criterion value in a case where the roller component has been replaced and judging whether a conveyance jam has occurred based on the criterion value after alteration; and
a reset step of clearing a counter value representing the number of times of use of the roller component in a case where it is determined in said judgment step that a conveyance jam has not occurred.

11. A control method for an image forming apparatus replaceably mounted with at least one roller component for recording sheet feed, comprising:
a count step of counting a number of times of use the roller component;
a detection step of detecting an occurrence of sheet feed jam during recording sheet feed by the roller component;
a judgment step of altering a criterion value for detection of sheet feed jam in said detection step to a predetermined criterion value in a case where the roller component has been replaced and judging whether a sheet feed jam has occurred based on the criterion value after alteration; and
a reset step of clearing a count value representing the number of times of use of the roller component in a case where it is determined in said judgment step that a sheet feed jam has not occurred.

12. A computer-readable storage medium storing a program for executing the control method as set forth in claim 10.

13. A computer-readable storage medium storing a program for executing the control method as set forth in claim 11.
